(19) United States
(12) Patent Application Publication
(10) Pub. No.: US 2025/0070473 A1
(43) Pub. Date: Feb. 27, 2025

(54) ANTENNA STRUCTURE AND ELECTRONIC DEVICE

(71) Applicant: Wistron NeWeb Corporation, Hsinchu (TW)

(72) Inventors: Hsieh-Chih LIN, Hsinchu (TW); Guan-Ren SU, Hsinchu (TW); Shih-Chiang WEI, Hsinchu (TW)

(21) Appl. No.: 18/679,894

(22) Filed: May 31, 2024

(30) Foreign Application Priority Data
Aug. 24, 2023 (TW) 112131877

(51) Int. Cl. H01Q 13/16; H01Q 13/22; H01Q 21/06

(52) U.S. Cl. CPC H01Q 13/16; H01Q 13/22; H01Q 21/064

(57) ABSTRACT

An antenna structure is disposed on a metal case. The metal case includes a surface. The antenna structure includes a slot and a metal unit. The slot is formed on the surface along a direction. The metal unit is disposed on the metal case. The metal unit includes at least one blocking part. The at least one blocking part is in contact with the surface, extended toward and crossed over the slot to separate the slot into a plurality of slot paths.

### RELATED APPLICATIONS

This application claims the benefit of priority to Taiwan Patent Application Serial No. 112131877, filed on Aug. 24, 2023. The entire content of the above identified application is incorporated herein by reference.

### BACKGROUND

### Technical Field

The present disclosure relates to an antenna structure and an electronic device, in particular to a slot antenna structure and an electronic device.

### Description of Related Art

In recent years, in addition to having good communication transmission quality, aesthetics and thinness of the electronic devices are also necessary conditions in the market. Furthermore, expectations for user experience of electronic devices are increasing. In the case of laptops, in response to the high demand for a large screen-to-body ratio, antenna structures tend to be positioned at the system end. However, the system end of laptops is densely packed, and the available space for antenna structure placement is greatly limited.

In light of this, setting up an antenna structure that can provide multi-band within a limited device space has become an important challenge in the field of antenna structure design.

### SUMMARY

According to an embodiment of structural configuration in the present disclosure, an antenna structure disposed on a metal case is provided. The metal case has a surface. The antenna structure includes a slot and a metal unit. The slot is formed on the surface along a direction. The metal unit is disposed on the metal case and includes at least one blocking part. The at least one blocking part is in contact with the surface, extended toward and crossed over the slot to separate the slot into a plurality of slot paths.

According to another embodiment of structural configuration in the present disclosure, an antenna structure disposed on a metal case is provided. The metal case has a surface. The antenna structure includes a slot and a metal unit. The slot is formed on the surface along a direction. The metal unit is disposed on the metal case and includes at least one blocking part. The at least one blocking part is in contact with the surface, extended toward and crossed over the slot to separate the slot into a plurality of slot paths. The metal unit is a clickable touch panel.

In yet another embodiment of structural configuration in the present disclosure, an electronic device including a metal case and an antenna structure is provided. The metal case has a surface. The antenna structure is disposed on the metal case and includes a slot and a metal unit. The slot is formed on the surface along a direction. The metal unit is disposed on the metal case and includes at least one blocking part. The at least one blocking part is in contact with the surface, extended toward and crossed over the slot to separate the slot into a plurality of slot paths.

### BRIEF DESCRIPTION OF THE DRAWINGS

The present disclosure can be more fully understood by reading the following detailed description of the embodiment, with reference made to the accompanying drawings as follows:

FIG. 1 is a schematic view of an antenna structure according to a first embodiment of the present disclosure.

FIG. 2 is a schematic view of slot paths as shown in FIG. 1.

FIG. 3 is a cross-sectional view of a slot and a metal unit in FIG. 1.

FIG. 4 is an overall frequency band waveform of frequency and return loss of the antenna structure as shown in FIG. 1.

FIG. 5 is a schematic view of an antenna structure according to a second embodiment of the present disclosure.

FIG. 6 is a schematic view of an antenna structure according to a third embodiment of the present disclosure.

FIG. 7 is a schematic view of slot paths as shown in FIG. 6.

FIG. 8 is a cross-sectional view of a slot and a metal unit as shown in FIG. 6.

FIG. 9 is an overall frequency band waveform of frequency and return loss of the antenna structure as shown in FIG. 6.

FIG. 10 is a schematic view of an antenna structure according to a fourth embodiment of the present disclosure.

FIG. 11 is a schematic view of an antenna structure according to a fifth embodiment of the present disclosure.

FIG. 12 is a schematic view of slot paths as shown in FIG. 11.

FIG. 13 is a schematic cross-sectional view of a slot and a metal unit as shown in FIG. 11.

FIG. 14 is an overall frequency band waveform of frequency and return loss of the antenna structure as shown in FIG. 11.

FIG. 15 is a schematic view of an antenna structure according to a sixth embodiment of the present disclosure.

FIG. 16 is a schematic view of an electronic device according to a seventh embodiment of the present disclosure.

FIG. 17 is a schematic exploded view of a base as shown in FIG. 16.

### DETAILED DESCRIPTION

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

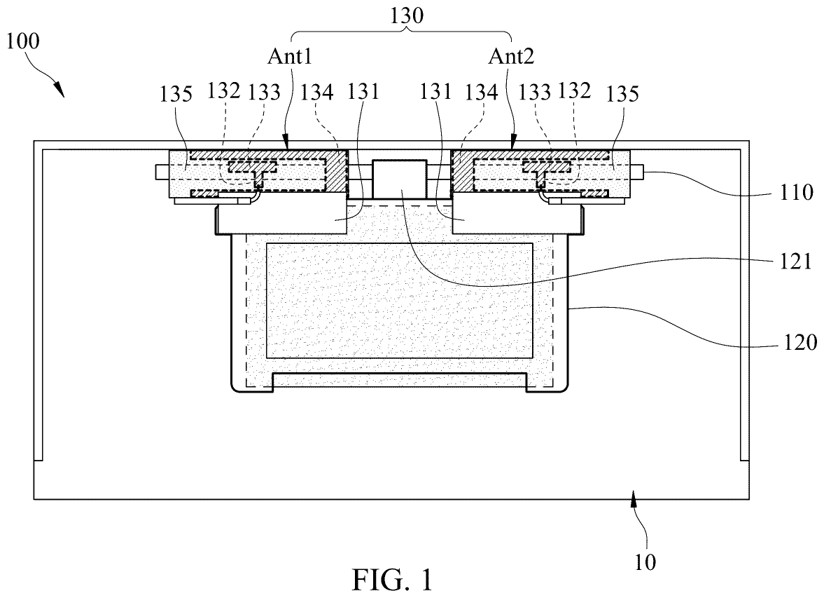

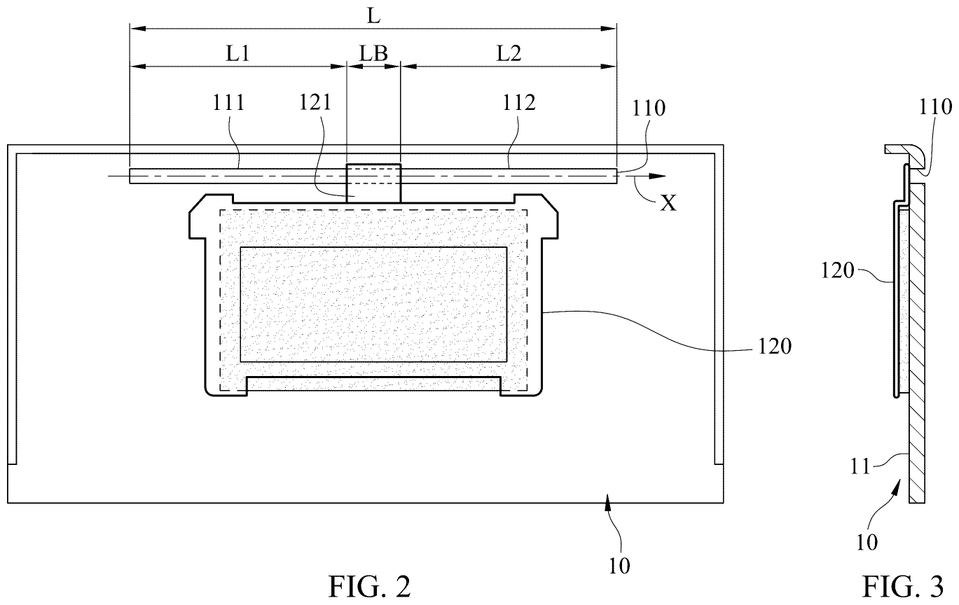

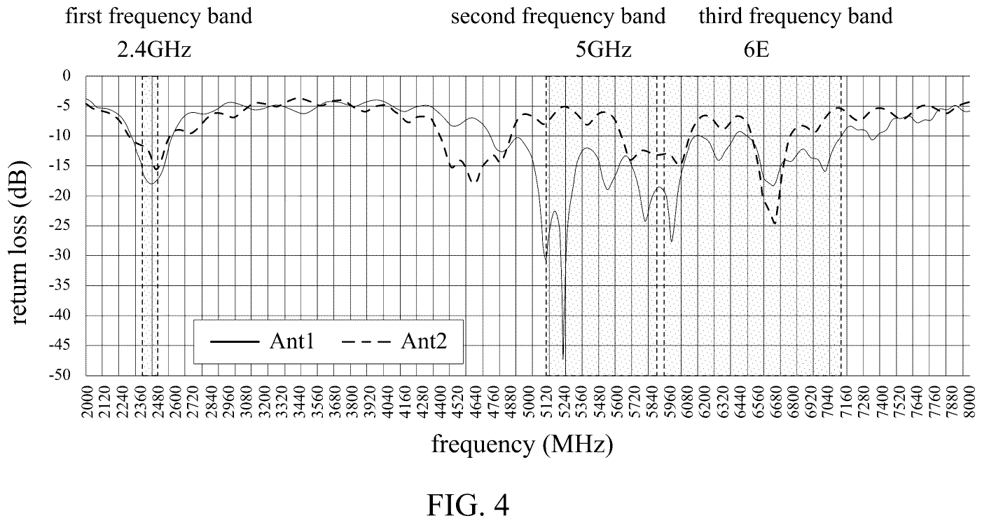

Referring to FIG. 1 to FIG. 4. FIG. 1 is a schematic view of an antenna structure 100 according to a first embodiment of the present disclosure. FIG. 2 is a schematic view of slot paths as shown in FIG. 1. FIG. 3 is a cross-sectional view of a slot 110 and a metal unit 120 as shown in FIG. 1. FIG. 4 is an overall frequency band waveform of frequency and return loss of the antenna structure 100 as shown in FIG. 1. The antenna structure 100 is disposed on a metal case 10. The metal case 10 has a surface 11. The antenna structure 100 includes a slot 110, a metal unit 120, and at least one antenna unit 130. The slot 110 is formed on the surface 11 along a direction X. The metal unit 120 and the antenna unit 130 are disposed on the metal case 10. The slot 110 is adjacent to the metal unit 120. In the first embodiment, the metal case 10 is a case of a D surface of a notebook computer. The surface 11 is on the D surface of the notebook computer. The metal unit 120 is a clickable touch panel of the notebook computer. The present disclosure is not limited thereto.

Referring to FIG. 2 and FIG. 3. The metal unit 120 includes at least one blocking part 121. The blocking part 121 is in contact with the surface 11, extended toward and crossed over the slot 110 to separate the slot 110 into a plurality of slot paths (reference number is omitted). Specifically, the blocking part 121 is joined to the surface 11 of two sides of the slot 110, enabling conduction between the surface 11 of the two sides of the slot 110, thereby creating a blocking effect and dividing the slot 110 into slot paths. In the first embodiment, the number of the at least one blocking part 121 is one. The slot paths include a first path 111 and a second path 112. The slot 110 has a slot length L along a direction X. The first path 111 has a length L1. The second path 112 has a length L2. The blocking part 121 has a blocking length LB along the direction X. The first path 111 and the second path 112 are spaced apart by the blocking length LB. The length L1 of the first path 111 and the length L2 of the second path 112 are greater than the blocking length LB. The length L1 can be equal to the length L2. In the first embodiment, the slot length L is 130 mm. Both the length L1 and the length L2 are 45 mm. The blocking length LB is 40 mm.

Referring to FIG. 1 and FIG. 2. The antenna unit 130 includes a ground part 131, a feeding part 132, a first radiating part 133, a second radiating part 134, and a substrate 135. The ground part 131 is connected to the second radiating part 134. The feeding part 132 is connected to the first radiating part 133. The substrate 135 is disposed on the surface 11. The ground part 131, the feeding part 132, the first radiating part 133, and the second radiating part 134 are disposed on the substrate 135. The ground part 131 is a ground copper foil, and is connected to a system ground of the notebook computer, but the present disclosure is not limited thereto. The first radiating part 133 and the second radiating part 134 feed a signal through the feeding part 132 to couple each of the slot paths to excite a resonant frequency corresponding to each of the slot paths. The feeding part 132 is electrically connected to a coaxial transmission line (not indicated in the figure) and is connected to a signal source to feed signals. A vertical projection of the substrate 135 on the surface 11 is partially corresponding to the slot 110 and partially corresponding to the metal unit 120. The substrate 135 can be a printed circuit board (PCB) or a flexible printed circuit (FPC), but the present disclosure is not limited thereto.

In this way, the antenna structure 100 is provided with a slot 110 formed on the D surface of the notebook computer, the blocking part 121 integrated on the clickable touch panel, and adjust the length of the slot path by joining the blocking part 121 at any position of the slot 110 according to the frequency band requirements, so that the antenna unit 130 can excite different frequency bands according to the slot path. The antenna structure 100 can be integrated into the notebook computer system in a limited installation space, while providing excellent antenna efficiency.

Referring to FIG. 1, FIG. 2, and FIG. 4. In the first embodiment, the number of the at least one antenna unit 130 is two, including a first antenna Ant1 and a second antenna Ant2 opposite to each other. The first antenna Ant1 and the second antenna Ant2 respectively correspond to the first path 111 and the second path 112. The first antenna Ant1 and the first radiating part 133 of the second antenna Ant2 are coupled to excite a resonant frequency of the first path 111 and the second path 112. The resonant frequency includes a first frequency band, a second frequency band, and a third frequency band. The first frequency band is between 2400 MHz and 2500 MHz. The second frequency band is between 5100 MHz and 5900 MHZ. The third frequency band is between 5900 MHz and 7100 MHz. The length L1 of the first path 111 and the length L2 of the second path 112 are smaller than or equal to ½ times the wavelength of the first frequency band.

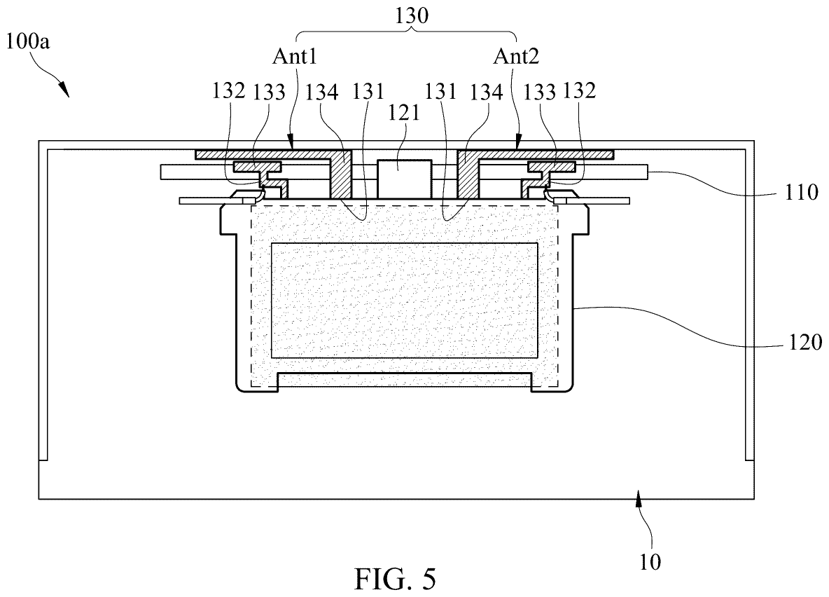

Referring to FIG. 5. FIG. 5 is a schematic view of an antenna structure 100a according to a second embodiment of the present disclosure. In the second embodiment, the antenna structure 100a also includes the slot 110, the metal unit 120, and the antenna unit 130 in the first embodiment as shown in FIG. 1 and FIG. 2. A difference between the antenna structure 100a in the second embodiment and the antenna structure 100 in the first embodiment is the types of the antenna unit 130. Specifically, the ground part 131, the first radiating part 133, and the second radiating part 134 of the antenna unit 130 are integrally formed with the metal unit 120. The feeding part 132 is disposed on the metal unit 120.

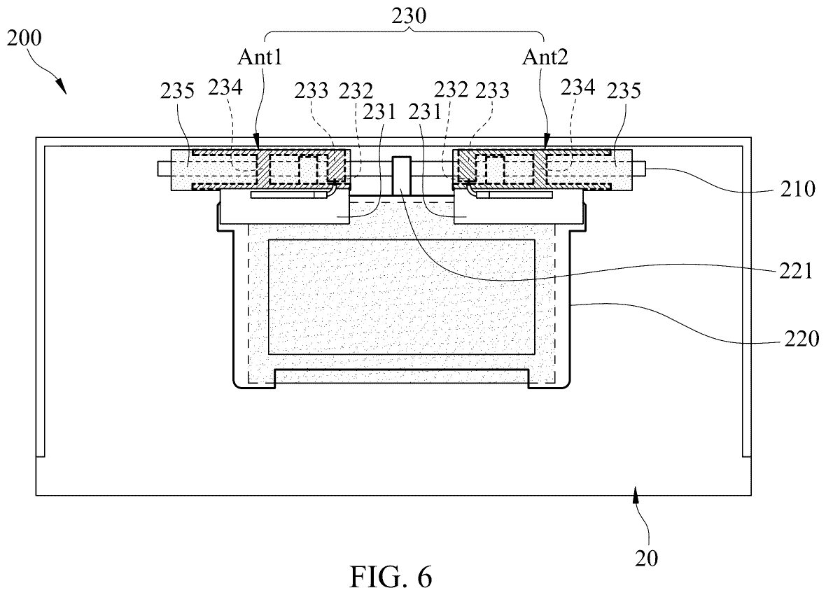

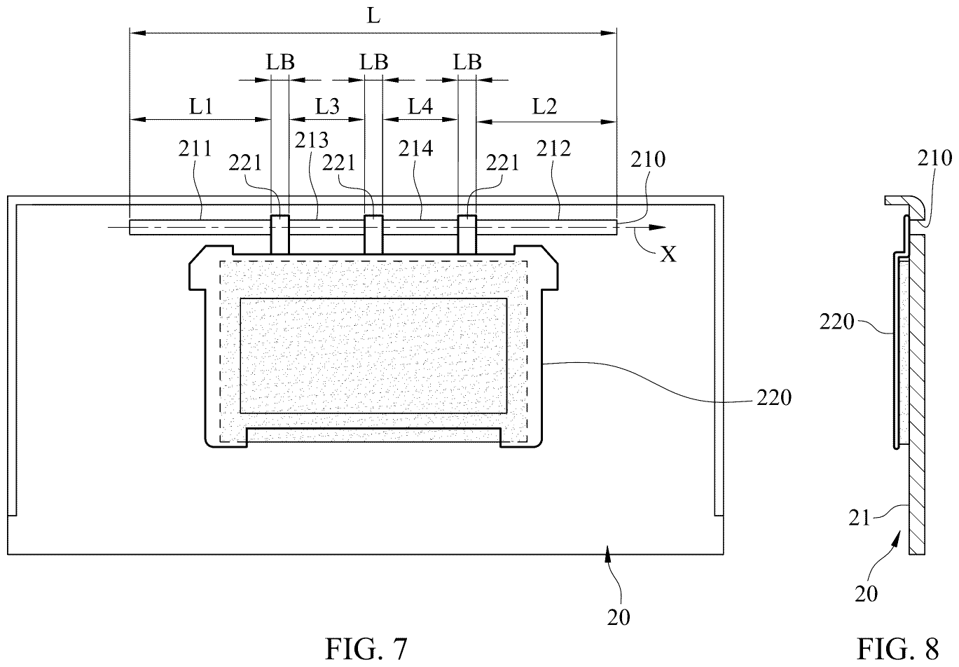

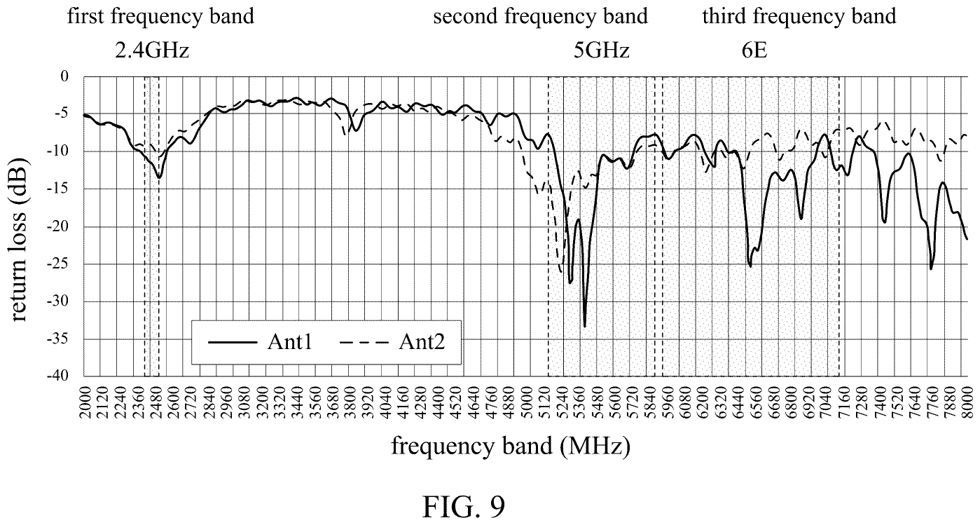

Referring to FIG. 6 to FIG. 9. FIG. 6 is a schematic view of an antenna structure 200 according to a third embodiment of the present disclosure. FIG. 7 is a schematic view of slot paths as shown in FIG. 6. FIG. 8 is a cross-sectional view of a slot 210 and a metal unit 220 as shown in FIG. 6. FIG. 9 is an overall frequency band waveform of frequency and return loss of the antenna structure 200 as shown in FIG. 6. The antenna structure 200 is disposed on a metal case 20. The metal case 20 has a surface 21. The antenna structure 200 includes a slot 210, a metal unit 220, and at least one antenna unit 230. The slot 210 is formed on the surface 21 along a direction X. The metal unit 220 and the antenna unit 230 are disposed on the metal case 20. The slot 210 is adjacent to the metal unit 220. In the third embodiment, the metal case 20 and the slot 210 are respectively the same as the metal case 10 and the slot 110 in the first embodiment, and will not be repeated herein.

Referring to FIG. 7 and FIG. 8. The metal unit 220 includes at least one blocking part 221. The blocking part 221 is in contact with the surface 21 and is extended toward and crossed over the slot 210 to separate the slot 210 into a plurality of slot paths (reference number is omitted). In the third embodiment, the number of the at least one blocking part 221 is three. The mean that the blocking part 221 divides the slot paths is the same as that of the blocking part 121 in the first embodiment, and will not be repeated herein. The slot paths divided by the blocking part 221 include a first path 211, a second path 212, a third path 213, and a fourth path 214. The slot 210 has a slot length L along the direction X. The first path 211 has a length L1. The second path 212 has a length L2. The third path 213 has a length L3. The fourth path 214 has a length L4. The blocking part 221 has a blocking length LB along the direction X. The blocking length LB is between the first path 211 and the second path 212, between the second path 212 and the third path 213, and between the third path 213 and the fourth path 214. The length L1 of the first path 211, the length L2 of the second path 212, the length L3 of the third path 213, and the length L4 of the fourth path 214 are greater than the blocking length LB. The length L1 is equal to the length L2. The length L3 is equal to the length L4. The length L1 is greater than the length L3. In the third embodiment, the slot length L is 130 mm. The length L1 and the length L2 are 45 mm. The length L3 and the length L4 are 15 mm. The blocking lengths LB are 3 mm.

Referring to FIG. 6 and FIG. 7. The antenna unit 230 includes a ground part 231, a feeding part 232, a first radiating part 233, a second radiating part 234, and a substrate 235. The ground part 231 and the first radiating part 233 are connected to the second radiating part 234. The feeding part 232 is connected to the first radiating part 233. The substrate 235 is disposed on the surface 21. The ground part 231, the feeding part 232, the first radiating part 233, and the second radiating part 234 are disposed on the substrate 235. In the third embodiment, the ground part 231, the feeding part 232, the first radiating part 233, the second radiating part 234, and the substrate 235 are respectively the same as the ground part 131, the feeding part 132, the first radiating part 133, the second radiating part 134, and the substrate 135 in the first embodiment, and will not be repeated herein.

Referring to FIG. 6, FIG. 7, and FIG. 9. In the third embodiment, the number of the at least one antenna unit 230 is two, including a first antenna Ant1 and a corresponding second antenna Ant2. The first radiating part 233 of the first antenna Ant1 corresponds to the third path 213. The second radiating part 234 of the first antenna Ant1 corresponds to the first path 211. The first radiating part 233 of the second antenna Ant2 corresponds to the fourth path 214. The second radiating part 234 of the second antenna Ant2 corresponds to the second path 212. The first radiating parts 233 respectively of the first antenna Ant1 and the second antenna 2 couples and excites a resonant frequency of the first path 211 and the second path 212. The resonant frequency includes a first frequency band, a second frequency band, and a third frequency band. The first frequency band is between 2400 MHz and 2500 MHz. The second frequency band is between 5100 MHz and 5900 MHz. The third frequency band is between 5900 MHz and 7100 MHz. The length L1 of the first path 211 and the length L2 of the second path 212 are smaller than or equal to ½ times the wavelength of the first frequency band. The third path 213 and the fourth path 214 are auxiliary path structures of medium and high frequencies (second frequency band, third frequency band).

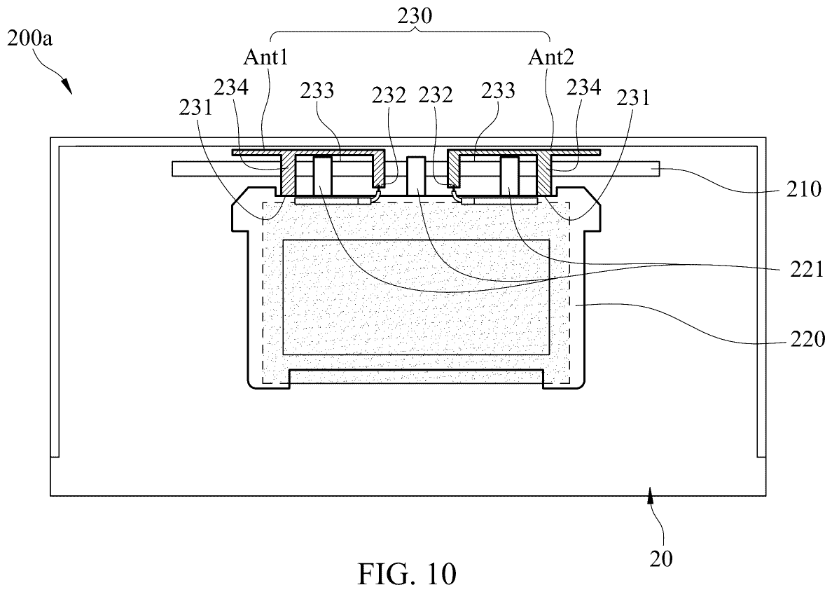

Referring to FIG. 10. FIG. 10 is a schematic view of an antenna structure 200a according to a fourth embodiment of the present disclosure. In the fourth embodiment, the antenna structure 200a also includes the slot 210, the metal unit 220, and the antenna unit 230 of the third embodiment as shown in FIG. 6 and FIG. 7. The difference between the antenna structure 200a in the fourth embodiment and the antenna structure 200 in the third embodiment is the types of the antenna unit 230. Specifically, the ground part 231, the first radiating part 233, and the second radiating part 234 of the antenna unit 230 are integrally formed with the metal unit 220. The feeding part 232 is disposed on the metal unit 220.

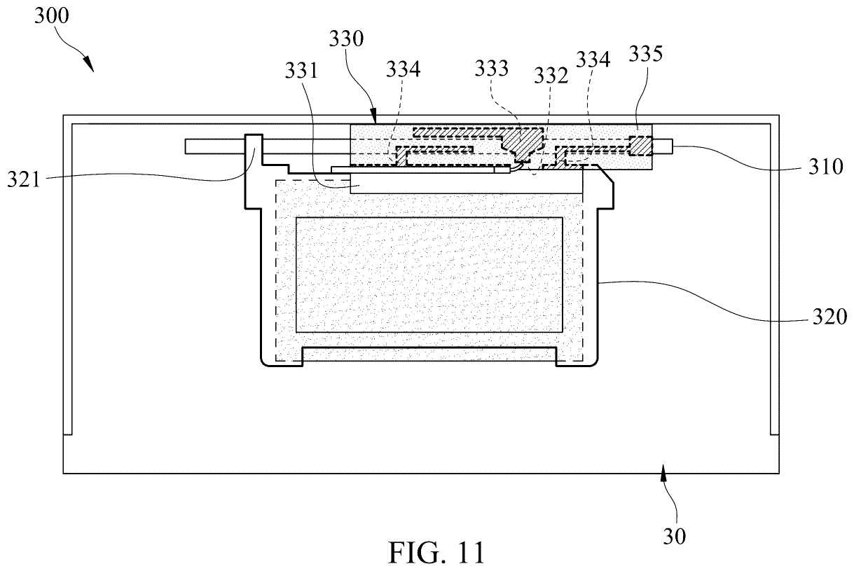

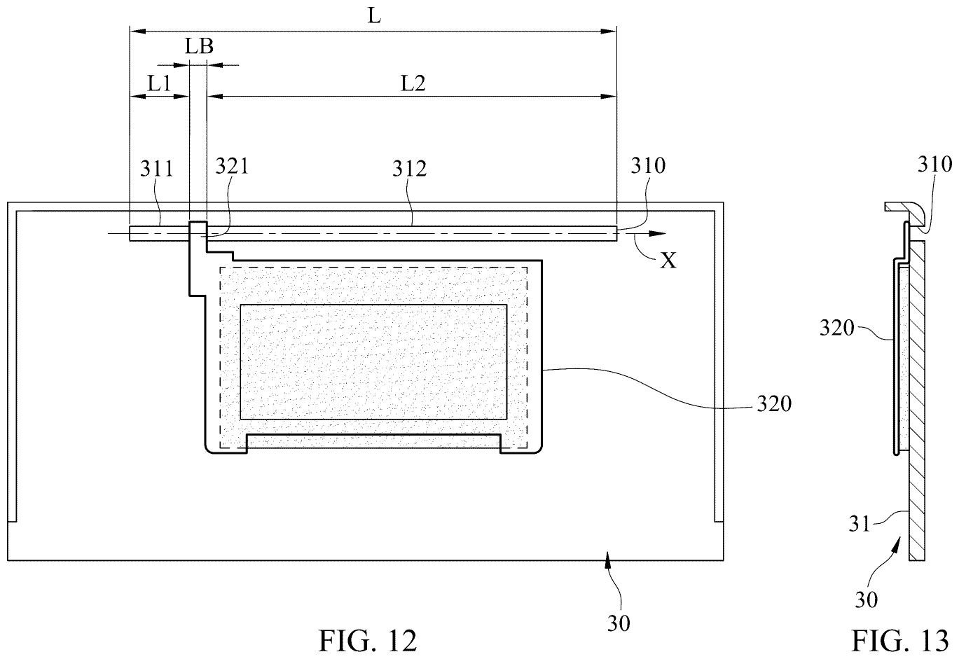

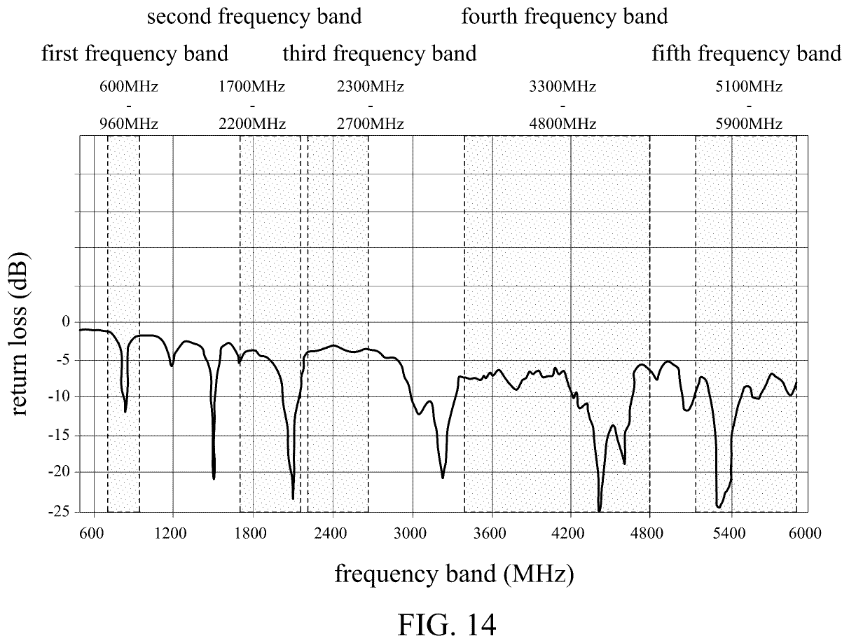

Referring to FIG. 11 to FIG. 14. FIG. 11 is a schematic view of an antenna structure 300 according to a fifth embodiment of the present disclosure. FIG. 12 is a schematic view of slot paths as shown in FIG. 11. FIG. 13 is a schematic cross-sectional view of a slot 310 and a metal unit 320 as shown in FIG. 11. FIG. 14 is an overall frequency band waveform of frequency and return loss of the antenna structure 300 as shown in FIG. 11. The antenna structure 300 is disposed on a metal case 30. The metal case 30 has a surface 31. The antenna structure 300 includes a slot 310, a metal unit 320, and at least one antenna unit 330. The slot 310 is formed on the surface 31 along a direction X. The metal unit 320 and the antenna unit 330 are disposed on the metal case 30. The slot 310 is adjacent to the metal unit 320. In the fifth embodiment, the metal case 30 and the slot 310 are respectively the same as the metal case 10 and the slot 110 in the first embodiment, and will not be repeated herein.

Referring to FIG. 12 and FIG. 13. The metal unit 320 includes at least one blocking part 321. The blocking part 321 is in contact with the surface 31, extended toward and crossed over the slot 310 to separate the slot 310 into a plurality of slot paths (reference number is omitted). In the fifth embodiment, the number of the at least one blocking part 321 is one. The mean that the blocking part 321 divides the slot paths is the same as that of the blocking part 121 in the first embodiment, and will not be repeated herein. The slot paths divided by the blocking part 321 include a first path 311 and a second path 312. The slot 310 has a slot length L along the direction X. The first path 311 has a length L1. The second path 312 has a length L2. The blocking part 321 has a blocking length LB along the direction X. The first path 311 and the second path 312 are spaced apart by the blocking length LB. The length L1 of the first path 311 and the length L2 of the second path 312 are greater than the blocking length LB. The length L1 is smaller than the length L2. In the fifth embodiment, the slot length L is 130 mm, the length L1 is 30 mm, the length L2 is 95 mm, and the blocking length LB is 5 mm.

Referring to FIG. 11 and FIG. 12. The antenna unit 330 includes a ground part 331, a feeding part 332, a first radiating part 333, a second radiating part 334, and a substrate 335. The ground part 331 is connected to the second radiating part 334. The feeding part 332 is connected to the first radiating part 333. The substrate 335 is disposed on the surface 31. The ground part 331, the feeding part 332, the first radiating part 333, and the second radiating part 334 are disposed on the substrate 335. In the fifth embodiment, the ground part 331, the feeding part 332, the first radiating part 333, the second radiating part 334, and the substrate 335 are respectively the same as the ground part 131, the feeding part 132, the first radiating part 133, the second radiating part 134, and the substrate 135 in the first embodiment, and will not be repeated herein.

Referring to FIG. 11, FIG. 12, and FIG. 14. In the fifth embodiment, the number of the at least one antenna unit 330 is one. The number of the second radiating part 334 is two and respectively disposed on two sides of the first radiating part 333. The first radiating part 333 couples and excites resonant frequencies of the first path 311 and the second path 312. The resonant frequencies include a first frequency band, a second frequency band, a third frequency band, a fourth frequency band, and a fifth frequency band. The first frequency band is between 600 MHz and 960 MHz. The second frequency band is between 1700 MHz and 2200 MHz. The third frequency band is between 2300 MHz and 2700 MHz. The fourth frequency band is between 3300 MHz and 4800 MHz. The fifth frequency band is between 5100 MHz and 5900 MHz. The length L2 of the second path 312 is smaller than or equal to ½ times the wavelength of the first frequency band.

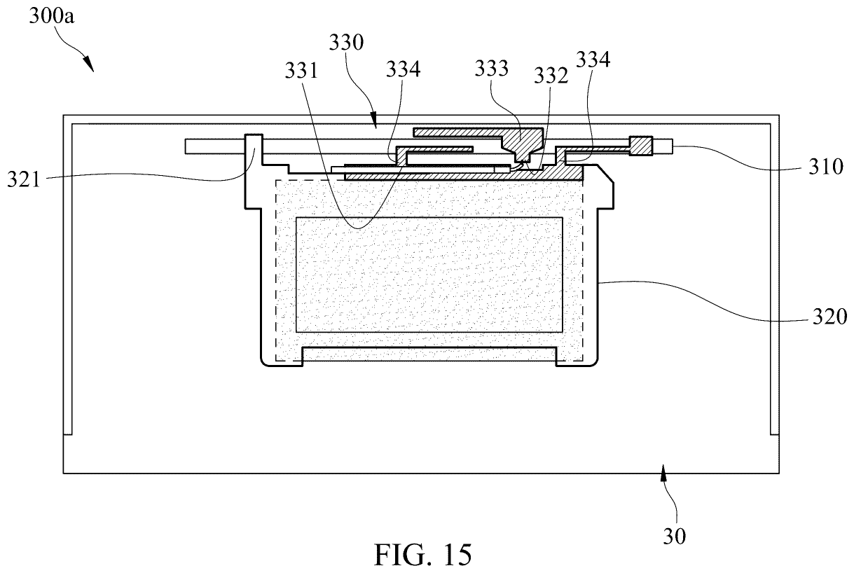

Referring to FIG. 15. FIG. 15 is a schematic view of an antenna structure 300a according to a sixth embodiment of the present disclosure. In the sixth embodiment, the antenna structure 300a also includes the slot 310, the metal unit 320, and the antenna unit 330 in the fifth embodiment as shown in FIG. 11 and FIG. 12. The difference between the antenna structure 300a in the sixth embodiment and the antenna structure 300 in the fifth embodiment is the types of the antenna unit 330. Specifically, the ground part 331, the first radiating part 333, and the second radiating part 334 of the antenna unit 330 are integrally formed with the metal unit 320. The feeding part 332 is disposed on the metal unit 320.

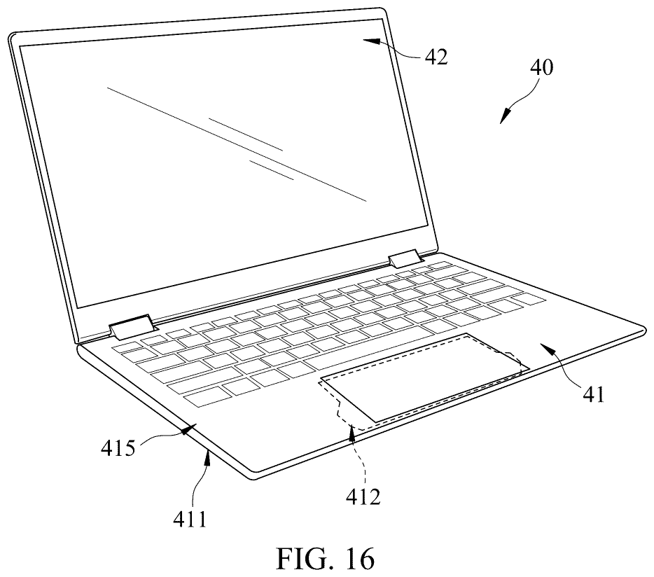

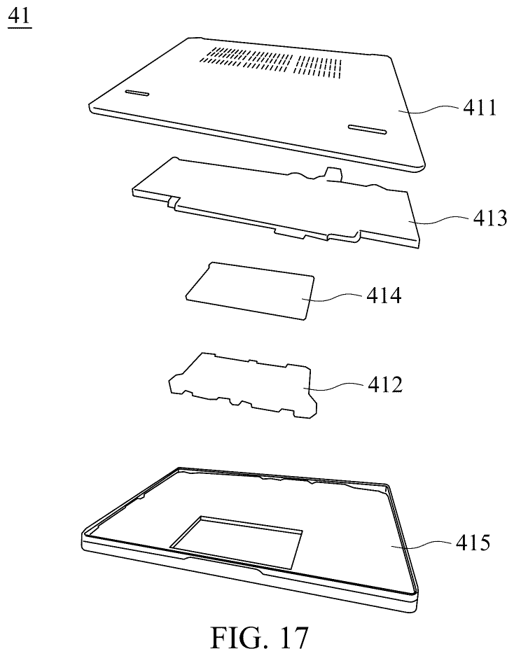

Referring to FIG. 16 and FIG. 17. FIG. 16 is a schematic view of an electronic device 40 according to a seventh embodiment of the present disclosure. FIG. 17 is a schematic exploded view of a base 41 as shown in FIG. 16. The electronic device 40 includes a base 41 and a display part 42. The base 41 includes a metal case 411, an antenna structure 412, a battery 413, a touch panel 414, and a system case 415. The antenna structure 412 is disposed at the metal case 411. In the seventh embodiment, the electronic device 40 is a notebook computer. The metal case 411 is a shell of the notebook computer D. The antenna structure 412 can be antenna structures 100, 100a, 200, 200a, 300, 300a from the first to the sixth embodiments as mentioned, but the present disclosure is not limited thereto.

From the above embodiments, the present disclosure has the following advantages. Firstly, the antenna structure of the present disclosure can be integrated into the system side of the electronic device by arranging a slot on the D surface of the notebook computer and integrating the blocking part on the clickable touch panel, thereby overcoming the problem of restricted antenna position. Secondly, the antenna structure of the present disclosure can excite transmission signals in multiple frequency bands by disposing the blocking part at the joint position of the slot and cooperating with the antenna unit.

The foregoing description of the disclosure has been presented only for the purposes of illustration and description option of the exemplary embodiments and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An antenna structure disposed on a metal case, the metal case having a surface, the antenna structure comprising:
a slot formed on the surface along a direction; and
a metal unit disposed on the metal case, comprising:
at least one blocking part in contact with the surface, extended toward and crossed over the slot to separate the slot into a plurality of slot paths.

2. The antenna structure according to claim 1, wherein the at least one blocking part has a blocking length along the direction, each of the slot paths are spaced apart by the blocking length, and a length of each of the slot paths are greater than the blocking length.

3. The antenna structure according to claim 1, wherein a number of the at least one blocking part is one, the slot paths comprise a first path and a second path, and wherein a length of the first path is smaller than or equal to a length of the second path.

4. The antenna structure according to claim 1, wherein a number of the at least one blocking part is three, the slot paths comprise a first path, a second path, a third path, and a fourth path, wherein a length of the first path is equal to the length of the second path, the length of the third path is equal to the length of the fourth path, and the length of the first path is greater than the length of the third path.

5. The antenna structure according to claim 1, further comprising:
at least one antenna unit disposed on the metal case, comprising:
a ground part;
a feeding part;
a first radiating part connected to the feeding part, the first radiating part feeding a signal through the feeding part to couple each of the slot paths to excite a resonant frequency corresponding to each of the slot paths; and
a second radiating part connected to the ground part.

6. The antenna structure according to claim 5, wherein the slot paths comprise a first path and a second path, the resonant frequency of the first radiating part coupled to excite each of the slot paths comprises a first frequency band, a second frequency band, and a third frequency band;
wherein the first frequency band is between 2400 MHz and 2500 MHZ, the second frequency band is between 5100 MHz and 5900 MHZ, the third frequency band is between 5900 MHz and 7100 MHz, and a length of the first path and a length of the second path are smaller than or equal to ½ times a wavelength of the first frequency band.

7. The antenna structure according to claim 5, wherein the slot paths comprise a first path and a second path, the resonant frequency of the first radiating part coupled to excite each of the slot paths comprises a first frequency band, a second frequency band, a third frequency band, a fourth frequency band, and a fifth frequency band;
wherein the first frequency band is between 600 MHz and 960 MHz, the second frequency band is between 1700 MHz and 2200 MHZ, the third frequency band is between 2300 MHz and 2700 MHZ, the fourth frequency band is between 3300 MHz and 4800 MHz, the fifth frequency band is between 5100 MHz and 5900 MHz, and a length of the second path is smaller than or equal to ½ times a wavelength of the first frequency band.

8. An antenna structure disposed on a metal case, the metal case having a surface, the antenna structure comprising:
a slot formed on the surface along a direction; and
a metal unit disposed on the metal case, comprising:
at least one blocking part in contact with the surface, extended toward and crossed over the slot to separate the slot into a plurality of slot paths;
wherein the metal unit is a clickable touch panel.

9. The antenna structure according to claim 8, wherein the at least one blocking part has a blocking length along the direction, each of the slot paths is spaced apart by the blocking length, and a length of each of the slot paths are greater than the blocking length.

10. The antenna structure according to claim 8, wherein a number of the at least one blocking part is one, the slot paths comprise a first path and a second path, and wherein a length of the first path is smaller than or equal to a length of the second path.

11. The antenna structure according to claim 8, wherein a number of the at least one blocking part is three, the slot paths comprise a first path, a second path, a third path, and a fourth path, wherein a length of the first path is equal to the length of the second path, the length of the third path is equal to the length of the fourth path, and the length of the first path is greater than the length of the third path.

12. The antenna structure according to claim 8, further comprising:
at least one antenna unit disposed on the metal case, comprising:
a ground part;
a feeding part;
a first radiating part connected to the feeding part, the first radiating part feeding a signal through the feeding part to couple each of the slot paths to excite a resonant frequency corresponding to each of the slot paths; and
a second radiating part connected to the ground part.

13. The antenna structure according to claim 12, wherein the slot paths comprise a first path and a second path, the resonant frequency of the first radiating part coupled to excite each of the slot paths comprises a first frequency band, a second frequency band, and a third frequency band;
wherein the first frequency band is between 2400 MHz and 2500 MHZ, the second frequency band is between 5100 MHz and 5900 MHZ, the third frequency band is between 5900 MHz and 7100 Mhz, and a length of the first path and a length of the second path are smaller than or equal to ½ times a wavelength of the first frequency band.

14. An antenna structure according to claim 12, wherein the slot paths comprise a second path, the resonant frequency of the first radiating part coupled to excite each of the slot paths comprises a first frequency band, a second frequency band, a third frequency band, a fourth frequency band, and a fifth frequency band;
wherein the first frequency band is between 600 MHz and 960 MHZ, the second frequency band is between 1700 MHz and 2200 MHZ, the third frequency band is between 2300 MHz and 2700 MHZ, the fourth frequency band is between 3300 MHz and 4800 MHZ, the fifth frequency band is between 5100 MHz and 5900 MHZ, and a length of the second path is smaller than or equal to ½ times a wavelength of the first frequency band.

15. The antenna structure according to claim 12, wherein the at least one antenna unit further comprises:
a substrate disposed on the surface, a vertical projection of the substrate on the surface partially corresponding to the slot and partially corresponding to the metal unit, the ground part, the feeding part, the first radiating part, and the second radiating part being disposed on the substrate.

16. The antenna structure according to claim 12, wherein the ground part, the first radiating part, and the second radiating part are integrally formed with the metal unit, and the feeding part is disposed on the metal unit.

17. An electronic device comprising:
a metal case having a surface; and
an antenna structure disposed on the metal case, comprising:
a slot formed on the surface along a direction; and
a metal unit disposed on the metal case, comprising:
at least one blocking part in contact with the surface, extended toward and crossed over the slot to separate the slot into a plurality of slot paths.

18. The electronic device according to claim 17, wherein the at least one blocking part has a blocking length along the direction, each of the slot paths are spaced apart by the blocking length, and a length of each of the slot paths are greater than the blocking length.

19. The electronic device according to claim 17, wherein a number of the at least one blocking part is one, the slot paths comprise a first path and a second path, and wherein a length of the first path is smaller than or equal to the length of the second path.

20. The electronic device according to claim 17, wherein a number of the at least one blocking part is three, the slot paths comprise a first path, a second path, a third path, and a fourth path, wherein a length of the first path is equal to the length of the second path, the length of the third path is equal to the length of the fourth path, and the length of the first path is greater than the length of the third path.
